(19) United States
(12) Patent Application Publication
(10) Pub. No.: US 2006/0259927 A1
(43) Pub. Date: Nov. 16, 2006

(54) Method and apparatus for providing remote access to subscription television services

(76) Inventors: Swarup Acharya, New Providence, NJ (US); Anurag Srivastava, Roselle, NJ (US)

Correspondence Address: Ryan, Mason & Lewis, LLP, 90 Forest Avenue, Locust Valley, NY, 11560, US

(21) Appl. No.: 11/130,329

(22) Filed: May 16, 2005

(51) Int. Cl. H04N 7/173; G06F 3/00; H04N 5/445; G06F 13/00

(52) U.S. Cl. 725/61; 725/86; 725/87

(57) ABSTRACT

A subscriber or other user is provided with access to one or more of a plurality of subscription services of a signal distribution system at a location remote from a home location of the user. The subscription services may be subscription television services, such as cable, satellite or Internet protocol television (IPTV) services, subscription audio services delivered via digital satellite radio, or other types of subscription services. Authentication information relating to the user is received, for example, in head end equipment, and processed to determine one or more of the plurality of subscription services that are accessible to the user at the home location. One or more media streams are then delivered to the remote location based on the determination as to which of the plurality of subscription services are accessible to the user at the home location.

### FIELD OF THE INVENTION

The present invention relates generally to signal distribution systems, and more particularly to techniques for distributing media streams associated with subscription services in cable television systems, satellite television systems, Internet protocol television (IPTV) systems, and other types of signal distribution systems.

### BACKGROUND OF THE INVENTION

Conventional signal distribution systems include, by way of example, cable television systems, satellite television systems, and systems providing IPTV over digital subscriber line (DSL) or fiber. Such systems are configured to distribute media streams associated with subscription television services to system subscribers or other users. Subscription television services are usually tied to a particular household or other predetermined subscriber location. Typically, a given subscriber is provided with an interface device, such as a set-top box or receiver, for communicating with system head end equipment. The interface device is configured to permit the subscriber to receive, on a television or other presentation device coupled to the interface device at a home location, the particular subscription television services to which that subscriber is entitled by virtue of the subscription. A given subscription may encompass, by way of example, a number of basic broadcast channels, as well as one or more premium programming channels, such as movie channels, sports channels, specialty channels, pay-per-view channels, on-demand video channels, etc.

A serious drawback of conventional cable, satellite and IPTV systems is that there is typically no roaming capability provided for subscribers. That is, subscribers generally must be at their respective home locations in order to receive the television services to which they have subscribed. By way of example, if a first subscriber leaves his or her home location and visits a remote location that also serves as a home location for a second subscriber, there is no mechanism provided for allowing the first subscriber to access his or her subscription television services at the second subscriber location. Thus, if the first subscriber has paid for access to a premium programming channel at his or her home location, that subscriber has no ability to access the premium programming channel at the remote location. This is the case even if the remote location, that is, the home location of the second subscriber, has the same television service provider and type of interface device as the home location of the first subscriber.

Previous attempts to address remote accessibility have failed to provide an adequate solution to the above-noted problem.

For example, U.S. Patent Application No. 2004/0116118 describes a media exchange network supporting remote peripheral access. In this approach, a media device has access to information in a “native service location.” The device is also permitted to roam, such that in a “non-native service location,” the media device is permitted to access the information available to it at its native service location. Unfortunately, this approach appears to require that a user carry a media device from location to location. Also, the information that is made available constitutes custom media streams developed by a given user, rather than subscription television services such as those accessible via a typical cable, satellite or IPTV system.

Another approach, described in U.S. Patent Application No. 2003/0030751, allows a subscriber to purchase a pay-per-view television event via a wireless communications device such as a cellular telephone. Thus, if the subscriber is away from his or her home location, the subscriber can nonetheless place an order with a cable or satellite television system for delivery of a particular pay-per-view television event. However, the remotely-ordered television event is still delivered by the cable or satellite television system to the home location of the subscriber. Accordingly, the subscriber is required to return to his or her home location in order to view the pay-per-view television event.

These and other conventional techniques fail to provide an arrangement whereby subscribers can access their usual home location subscription television services when at remote locations, without the need for carrying media devices, communications devices or other equipment to the remote locations.

It is therefore apparent that a need exists for improved techniques for providing roaming subscribers with access to subscription services.

### SUMMARY OF THE INVENTION

The present invention in an illustrative embodiment meets the above-identified need by allowing roaming users to access their home location subscription television services at remote locations. The techniques can be extended to other types of subscription services, such as subscription audio services delivered via digital satellite radio.

In one aspect of the invention, a subscriber or other user is provided with access to one or more of a plurality of subscription services of a signal distribution system at a location remote from a home location of the user. The subscription services may be subscription television services, such as cable, satellite or IPTV services, subscription audio services delivered via digital satellite radio, or other types of subscription services. Authentication information relating to the user is received, for example, in head end equipment, and processed to determine one or more of the plurality of subscription services that are accessible to the user at the home location. One or more media streams are then delivered to the remote location based on the determination as to which of the plurality of subscription services are accessible to the user at the home location.

As an example, the plurality of subscription television services may comprise a plurality of broadcast channels and a plurality of premium programming channels. If the broadcast channels and at least a given one of the premium programming channels are accessible to the user at the home location, and only the broadcast channels would otherwise be accessible at the remote location, one or more media streams corresponding to the given premium programming channel may be delivered to the remote location.

The one or more streams delivered to the remote location may comprise at least a first media stream delivered to the remote location from first head end equipment associated with the home location and a second media stream delivered to the remote location from second head end equipment associated with the remote location.

In accordance with another aspect of the invention, a billing record may be generated in the system to reflect charges for delivery of the one or more media streams to the remote location. These charges may be combined with charges associated with providing access to the one or more subscription services to the user at the home location, so that the user is presented with a single bill.

Advantageously, the present invention in an illustrative embodiment provides roaming subscriber access to subscription television services without requiring the subscriber to carry any particular equipment to the remote location. The services available to the subscriber at his or her home location can be efficiently replicated in whole or in part at the remote location, thereby enhancing the user experience while also providing a significant source of additional revenue for service providers.

### BRIEF DESCRIPTION OF THE DRAWINGS

FIG. 1A shows an illustrative embodiment of a signal distribution system in accordance with the invention.

FIG. 1B shows a simplified block diagram of an interface device of the FIG. 1A system.

FIG. 2 is a flow diagram illustrating the operation of the FIG. 1A system under one possible operating scenario of the illustrative embodiment.

FIGS. 3A and 3B show examples of signal distribution systems configured to provide roaming television services for subscribers within a common local area.

FIG. 4 shows an example of a signal distribution system configured to provide roaming television services for subscribers across a wider geographic region.

FIG. 5 shows an example of a signal distribution system configured to provide roaming television services for subscribers over a potentially global area.

### DETAILED DESCRIPTION OF THE INVENTION

The invention will be illustrated herein in conjunction with illustrative embodiments of signal distribution systems. It should be understood, however, that the invention is not limited to use with the particular systems and techniques described, but is instead more generally applicable to any signal distribution application in which it is desirable to provide improved roaming capabilities to system users. For example, although described herein primarily in the context of subscription television services, the techniques of the invention can also be adapted in a straightforward manner to subscription audio services, such as those delivered via digital satellite radio systems. Systems of the latter type are considered a type of signal distribution system as that term is used herein.

The term “subscription” as used herein is intended to include a variety of arrangements for charging a user for access to media streams, and should not be construed as requiring any particular type of billing arrangement or regular access period, such as weekly, monthly, yearly, etc.

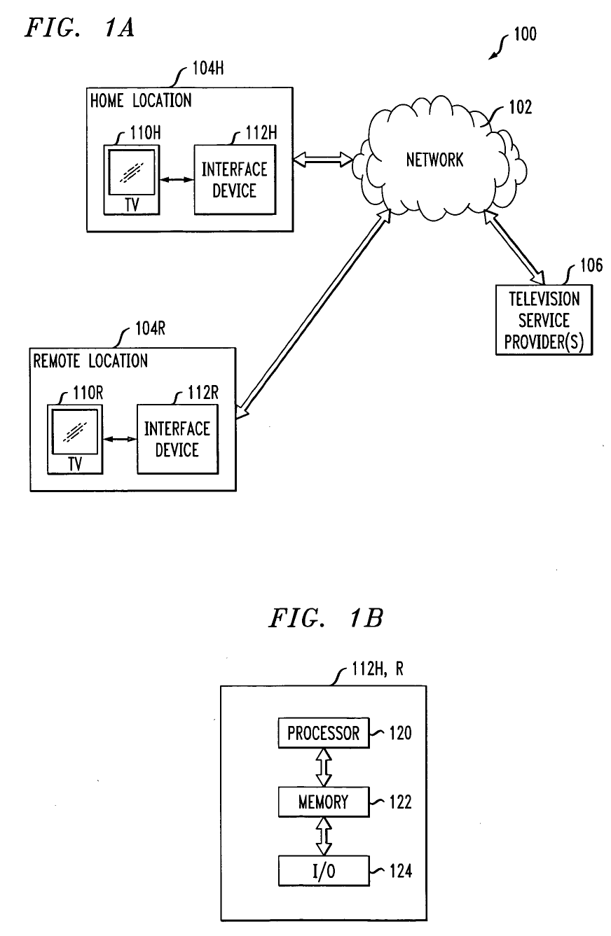

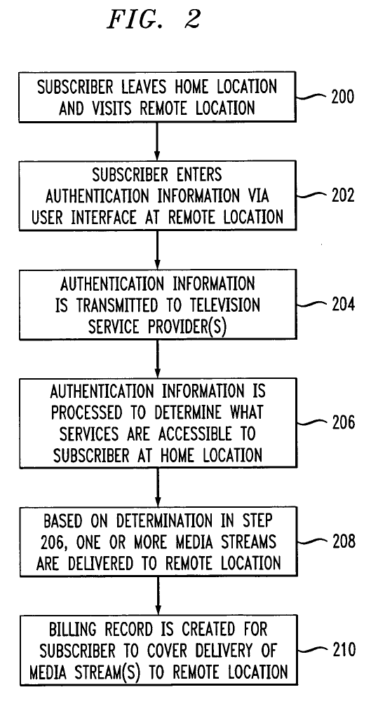

Referring now to FIG. 1A, a signal distribution system 100 comprises a network 102 over which equipment at a home location 104H and a remote location 104R communicates with one or more television service providers 106. The signal distribution system 100 may comprise, by way of example, a cable television system, a satellite television system, a system for providing IPTV over DSL or fiber, or portions or combinations of these and other systems. Element 106 may comprise, for example, otherwise conventional service provider head end equipment, including, for example, cable head end systems, satellites, servers, etc. The equipment at the home location 104H comprises a television 110H coupled to an interface device 112H. Similarly, the equipment at the remote location 104R comprises a television 110R coupled to an interface device 112R. The interface devices 112 may comprise, for example, set-top boxes, receivers, computers, or other processor-based devices, in any combination. The interface device may be a stand-alone device, or may be combined with the television into a single device.

It should be noted that the invention does not require the use of a television or any other particular type of presentation arrangement. For example, subscription television services could be delivered to a computer, mobile telephone, personal digital assistant (PDA), or other type of processor-based device using the techniques of the invention. Such devices are therefore intended to be included within the scope of the term “interface device” as used herein. A given interface device may therefore, by way of example, combine interface functionality with television display functionality.

An example of an implementation of the latter type may involve a system in which the home location comprises a particular mobile telephone to which television subscription services are delivered in accordance with a subscription, while the remote location comprises another mobile telephone which would not otherwise have access to the same television subscription services absent use of the techniques described herein.

The network 102 may comprise any type of communication network suitable for transporting signals associated with the provision of subscriber television services, and the invention is not limited in this regard. For example, portions of the network 102 may comprise local area networks, wide area networks, the Internet, satellite networks, cellular telephone networks, IEEE 802.11 networks, etc.

The home location 104H is a designated home location of a particular system subscriber. Thus, it is a location at which the subscriber is permitted to access one or more television services by virtue of his or her subscription. It should be noted that the term “subscriber” as used herein is intended to encompass other subscribing entities, such as businesses or organizations, in addition to individuals or families. Subscribers may be viewed as examples of what are more generally referred to herein as users, and the term “user” is thus intended to include subscribers as well as other types of users. Also, the term “home” should be construed broadly, and is not intended to be restricted to individual or family residences. Instead, the home location of a particular subscriber may be a primary location of that subscriber, or more generally any location at which that subscriber ordinarily accesses subscription services in accordance with the subscription. A home location may therefore be at a business facility, hotel or other building, in a means of conveyance such as an automobile, train, bus or airplane, or at any other suitable location. A “remote” location may be a secondary location of a given subscriber, or more generally any location other than the home location for that subscriber.

A home location for a given subscriber may serve as a remote location for another subscriber or subscribers. The remote location 104R therefore may be a home location for another system subscriber. Accordingly, remote location 104R, like home location 104H, is also equipped with a television and an interface device as shown. In other embodiments, the remote location need not be a home location for any particular subscriber. For example, the remote location may be a room or other area in a hotel or means of conveyance that is intended to serve multiple subscribers over a given period of time.

It is to be appreciated that the invention does not require any particular geographic relationship between the home location 104H and the remote location 104R. Accordingly, the two locations may be within the same local area, served by a common service provider. As another example, the two locations may be more geographically remote from one another, such as in different regions of the same country, or even in different countries, with the two locations being serviced by different television service providers. It is also possible that the home and remote locations may be in a common building or other structure, for example, in respective first and second apartments of an apartment building. Numerous alternative arrangements are possible, as will be apparent to those skilled in the art.

FIG. 1B illustrates that a given one of the interface devices 112H, 112R comprises a processor 120, a memory 122, and input/output (I/O) elements 124. The processor 120 may be, e.g., a microprocessor, a microcontroller, an application-specific integrated circuit (ASIC) or other type of processing device, as well as portions or combinations of such devices. The memory 122 may include an electronic random access memory (RAM), a read-only memory (ROM) or other type of storage device, as well as portions or combinations of such devices. The processor 120 and memory 122 are used in storage and execution of one or more software programs for implementing roaming television services of a type to be described in greater detail below.

The particular signal distribution system configuration described above should be viewed as an illustrative example of a roaming television services arrangement in accordance with the invention, and it is to be understood that the invention can be implemented using other types and configurations of system components.

As noted above, a conventional cable, satellite or IPTV system does not provide an ability for a given system subscriber to access his or her subscription television services when away from his or her designated home location. Thus, if a first subscriber has paid for access to a premium programming channel at home location 104H, that subscriber has no ability to access the premium programming channel at the remote location 104R, even though the two locations may be serviced by a common television service provider, and may have the same type of interface device 112.

The illustrative embodiment of the invention overcomes this significant drawback of conventional practice by configuring elements of system 100 to support roaming television services. Generally, a roaming television services technique in this embodiment allows a subscriber to access his or her subscription television services when away from his or her designated home location. As noted previously, in other embodiments of the invention the roaming techniques may be applied to non-television services, such as subscription audio services delivered via digital satellite radio or other arrangements.

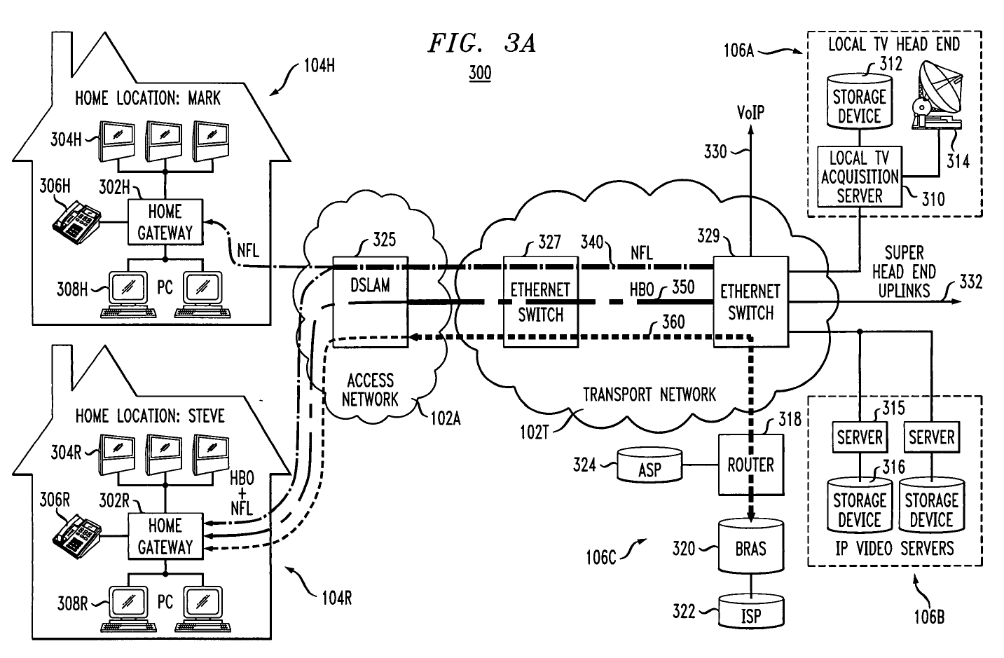

FIG. 2 shows one example of a roaming television services technique that is implemented in the system of FIG. 1A. The technique is implemented at least in part in the form of software that is executed by system elements such as one or more interface devices and the head end equipment of one or more television service providers.

In step 200, a subscriber leaves home location 104H and visits remote location 104R. As mentioned previously, the remote location 104R may be the home or business of another subscriber, a hotel, an automobile, an airplane, etc.

The subscriber enters authentication information in step 202, such as an account name and password, via a user interface at the remote location. The interface may be provided, for example, using the interface device 112R in combination with television 110R, such that the subscriber can enter the information using a remote control device of the television. The authentication information entered by the subscriber is transmitted over network 102 to the appropriate television service provider(s), as indicated in step 204.

It should be noted that the authentication information may be provided from the remote location to the service provider using any suitable technique. For example, the subscriber may manually enter the information and then enter a transmit command, or the process may occur automatically, with the authentication information, other than a password or other secure information, being transferred wirelessly from a device carried by the subscriber to the interface device. Clearly, a wide variety of alternative techniques are possible for entering, storing, transferring, transmitting or processing authentication information. The term “authentication information” as used herein is intended to be construed broadly, so as to cover any type of information suitable for establishing the identity of the subscriber to the satisfaction of the service provider(s).

At least one television service provider in step 206 processes the received authentication information in order to determine what subscription television services, if any, are accessible to the subscriber at the home location 104H. This determination may involve, for example, accessing a subscriber database to determine subscriber information associated with the particular subscriber.

Based on the determination made in step 206, one or more media streams are delivered to the remote location, as indicated in step 208. Thus, the subscriber, once authenticated, is provided with an ability to access, at the remote location 104R, subscription television services that would otherwise be accessible to the subscriber only at the home location 104H.

As an illustrative example, consider an arrangement in which the subscription television services accessible to the subscriber at the home location comprise a plurality of broadcast channels and at least a given one of a plurality of premium programming channels. Further assume that only the broadcast channels would otherwise be accessible to the subscriber at the remote location, absent use of the FIG. 2 process. In this scenario, step 208 of the FIG. 2 process may involve delivering to the remote location one or more media streams corresponding to the given premium programming channel. It was indicated previously herein that such premium programming channels may include, by way of example, movie channels, sports channels, specialty channels, pay-per-view channels, on-demand video channels, etc.

It should be noted that delivery of the media stream(s) in step 208 may involve adaptation of the stream(s) to meet the particular display requirements of the remote location. For example, transcoding or other adaptation may be applied to the media stream(s) using suitable interworking functions implemented at the remote location, in the head end equipment, or elsewhere in the signal distribution system.

As indicated in step 210, a billing record is created for the subscriber, typically by the service provider, in order to cover delivery of the media stream(s) to the remote location. This advantageously provides an ability for service providers to generate additional revenues from their subscribers. The charges may included as part of the usual bill that is generated for the home location services of the subscriber. That is, the charges of the billing record created in step 210 may be combined with charges associated with providing access to subscription television services to the subscriber at the home location. Of course, alternative billing arrangements may be used, such as including a certain number of remote accesses within a fixed monthly or yearly fee, and so on.

There are many situations in which subscribers would pay additional reasonable fees in order to access from a remote location the subscription television services which would otherwise only be accessible to them at their respective home locations. An example of such a scenario is one in which the remote location is a hotel room to be temporarily occupied by a subscriber. Such a subscriber would often prefer to receive, for an additional reasonable fee, access to the subscription television services provided at his or her home location, rather than watch the basic cable or satellite system programming typically made available free of charge to all hotel guests. For example, using the FIG. 2 process, the subscriber could receive a premium programming channel that is part of his or her home subscription, or could receive the local broadcast news channels that are part of the home subscription rather than only those broadcast channels which are local to the hotel. The approach is similarly advantageous in numerous other scenarios involving a variety of remote locations.

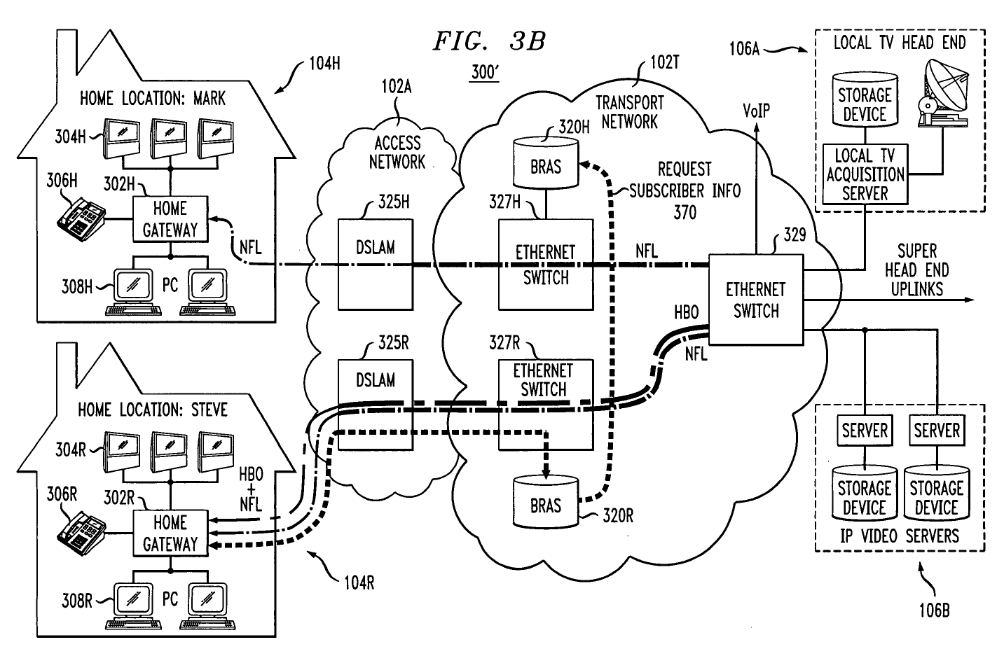

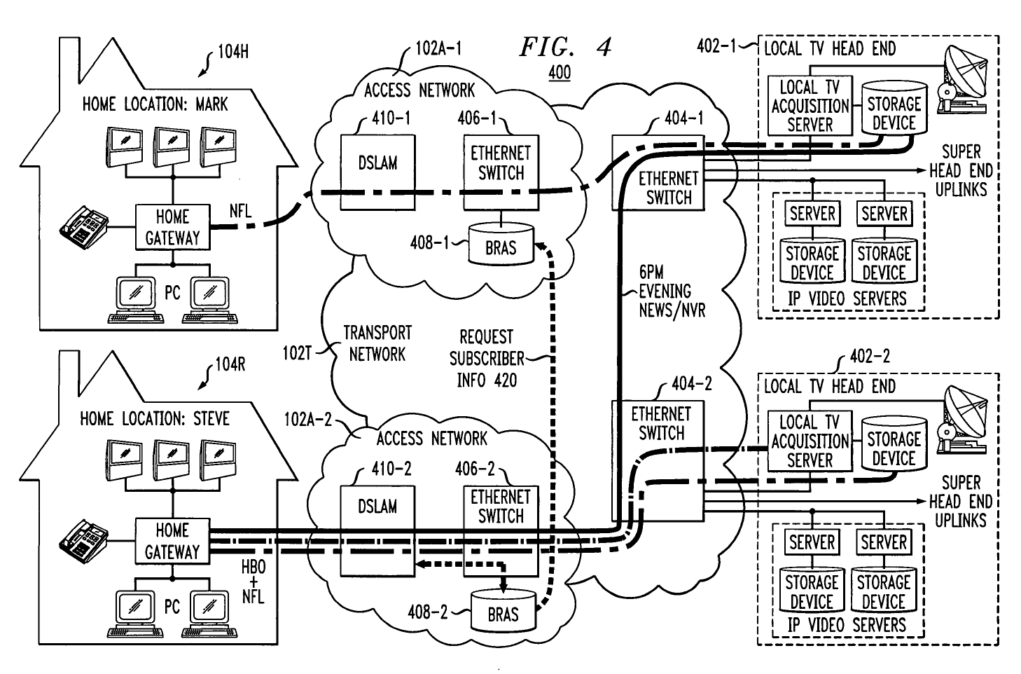

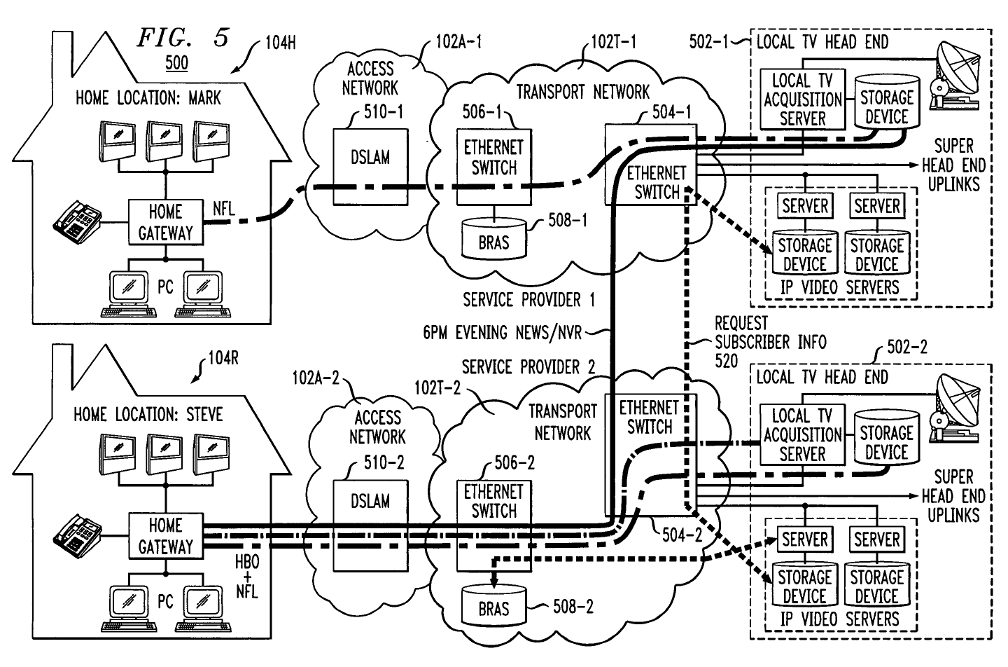

Particular implementations of the FIG. 2 process will now be described with reference to exemplary system diagrams of FIGS. 3, 4 and 5. The systems and associated processes illustrated in these drawings are examples of the more general system and process described in conjunction with FIGS. 1 and 2, respectively. FIG. 3 illustrates local roaming arrangements, where the home location and remote location are within a common local area, served by the same head end equipment of a given service provider. FIG. 4 illustrates regional roaming arrangements, where the home location and the remote location are further geographically separated, so as to be served by separate head end equipment, possibly from different service providers. The arrangements shown in FIG. 5 involves a further separation of home and remote locations, so as to support a potentially global roaming functionality, using separate head end equipment from different service providers.

In these illustrative embodiments, it is assumed that the home and remote locations are coupled to the system network via DSL connections. The systems to be described may therefore be viewed as exemplary implementations of systems for providing IPTV over DSL. However, it is to be understood that the invention can be implemented using cable or satellite connections to the home and remote locations, IPTV over fiber connections, or other types of connections, in any combination.

Referring initially to FIG. 3A, a signal distribution system 300 is configured to permit roaming of a first subscriber, Mark, having home location 104H, to a remote location 104R. In this embodiment, the remote location 104R is the home location of another subscriber, Steve. Each of the two locations in this embodiment has substantially the same equipment, namely, a home gateway 302H or 302R, televisions 304H or 304R, a telephone 306H or 306R, and personal computers (PCs) 308H or 308R. The televisions 304H or 304R are assumed to have associated therewith at least one interface device 112 of the type described previously, although such devices are not explicitly shown in the figure. Additionally or alternatively, the home gateway 302H or 302R may incorporate at least a portion of the functionality of the interface device 112 as previously described. The home gateway is therefore considered an example of a type of interface device as the latter term is used herein.

The system 300 further includes a network 102, more specifically comprising an access network 102A and a transport network 102T. The network 102 connects the locations 104H and 104R to television service provider(s) 106 which more specifically comprise television service provider head end equipment 106A, 106B and 106C. Elements 106A and 106B are also referred to herein as video head end equipment.

The term “head end equipment” as used herein is intended to be construed generally so as to encompass any type of service provider equipment which may be used to provide one or more media streams to a transport network or other communication channel for delivery to one or more subscribers. Thus, such equipment need not be located at any particular point in a given system. Also, various combinations of different pieces of equipment at different locations in the system may comprise head end equipment as that term is used herein.

The head end equipment 106A in the FIG. 3A embodiment comprises a local television broadcast channel head end which includes a local television acquisition server 310, a storage device 312, and satellite communication equipment 314. The head end equipment 106B comprises IP video servers, including servers 315 and storage devices 316. The head end equipment 106C comprises a router 318 that is coupled via a broadband remote access server (BRAS) 320 to an Internet service provider (ISP) 322. The router 318 is also coupled to an application service provider (ASP) 324. The BRAS 320 in this embodiment stores subscriber information, although such information can of course be stored elsewhere in the system 300.

The access network 102A in this embodiment comprises a DSL access multiplexer (DSLAM) 325 which is coupled via DSL connections to the locations 104H and 104R. The DSLAM 325 is coupled to the television service provider equipment 106A, 106B and 106C via Ethernet switches 327 and 329 of the transport network 102T. The Ethernet switch 329 also couples to voice-over-IP (VoIP) equipment and super head end equipment, not explicitly shown in the figure, via respective connections 330 and 332. A super head end generally refers to a combination of multiple head ends subject to common control.

It is to be appreciated that the particular arrangement of system elements shown in this and other figures herein is presented by way of illustrative example only. Numerous alternative configurations of system equipment may be used to implement the described roaming techniques. For example, although shown in this embodiment as separate elements, the BRAS and DSLAM elements may have their respective functionalities combined into a single network element in an alternative embodiment. Also, although the transport network is shown as comprising Ethernet switches, other types of switches, routers or hubs, in any combination, may be used.

In operation, it is assumed that the first subscriber Mark receives as part of his subscription television services at home location 104H a first premium programming channel, namely, an NFL® (National Football League) sports channel. A corresponding media stream is delivered from television service provider(s) 106 to DSLAM 325 via Ethernet switches 327 and 329 as indicated generally at 340. Mark can access the NFL® channel via one or more of the televisions 304H at his home location 104H in accordance with his subscription, with the DSLAM 325 supplying the corresponding media stream to the home gateway 302H of location 104H.

Similarly, the second subscriber Steve receives as part of his subscription television services at home location 104R a second premium programming channel, namely, a movie channel such as an HBO® (Home Box Office) movie channel. A corresponding media stream is delivered from television service provider(s) 106 to DSLAM 325 via Ethernet switches 327 and 329 as indicated generally at 350. Steve can access the HBO® channel via one or more of the televisions 304R at his home location 104R in accordance with his subscription, with the DSLAM 325 supplying the corresponding media stream to the home gateway 302R of location 104R.

As noted above, the system 300 allows the first subscriber Mark to have roaming access to his subscription television services. The figure illustrates an arrangement in which Mark roams to Steve's house, that is, to remote location 104R. Mark provides authentication information via an interface device at location 104R, possibly by entering an account name and password via a remote control device associated with one of the televisions 304R. Such information may be provided, for example, over connection 360 to BRAS 320 of the television service provider head end equipment 106C. The television service provider(s) then determine from the authentication information and the subscription information stored in BRAS 320 what subscription television services are accessible to Mark at his home location 104H.

In this example, it is determined that Mark has access to the NFL® channel at his home location 104H. In conjunction with entry of his authentication information, Mark may have also indicated a request for access to that channel at the remote location 104R. Additionally or alternatively, such a request may be entered subsequent to and separate from the entry of the authentication information. Upon confirmation of the authentication information, accessibility to the NFL® channel at the home location 104H, and the request for access to the NFL® channel at remote location 104R, the system 300 directs DSLAM 325 to deliver the corresponding media stream to the remote location 104R. Thus, Mark has been provided with roaming access to subscription television services which would otherwise only be available to him at his home location 104H. As shown, media streams associated with both the NFL® channel and the HBO® channel are now delivered to remote location 104R.

An appropriate bill may be generated in the system 300 to charge Mark for the delivery of the NFL® channel to the location 104R. Additionally or alternatively, Steve may be billed for at least a portion of the service. The delivery of the NFL® channel to the remote location 104R may continue for a designated period of time, such as several hours, for the duration of a particular program or event, or based on other conditions. Such conditions may be specified in the authentication information or any associated access request.

In the FIG. 3A embodiment, the roaming is considered local in that the home location 104H and the roaming location 104R are part of the same television service provider network, and are serviced by the same DSLAM. Since the two locations are served by the same DSLAM, the same content can be readily made available at either location via reconfiguration of the DSLAM. As one possible variant, the home location 104H and remote location 104R may be served by different DSLAMs. In this case, the DSLAM serving the remote location is reconfigured to allow delivery of the NFL® channel media stream to the remote location.

FIG. 3B illustrates a further local roaming variant comprising a system 300′ in which the home and remote locations 104H, 104R are served by respective first and second DSLAMs 325H and 325R and respective first and second BRAS 320H and 320R. The BRAS 320H and 320R are coupled to respective Ethernet switches 327H and 327R. The BRAS 320R may not store subscriber information for the roaming subscriber Mark, and thus this BRAS issues a request for the needed subscriber information to the BRAS 320H. Based on the supplied subscriber information, the authentication information can be confirmed, and the remote access request processed, with generation of billing events as appropriate. A separate control network may be used to interconnect the BRAS elements of the system so as to facilitate the exchange of subscriber information between such elements. Such a control network may comprise, for example, a centralized entity such as an operations support system or a billing system resident in head end equipment or another centralized place. As another example, the information can be obtained from a centralized database at a head end or super head end, via an Internet connection with a centralized storage device, or using other techniques.

In both the FIG. 3A and FIG. 3B scenarios, the home and remote locations 104H, 104R are both served by the same video head end equipment 106A and 106B. Thus, the remote location can be readily reconfigured to obtain access to the same programming as the home location without rerouting of media streams.

FIG. 4 illustrates a regional roaming scenario in which the remote location is not only served by different DSLAM and BRAS elements than the home location but also operated under the control of different video head end equipment than the home location. Signal distribution system 400 comprises first video head end equipment 402-1, also referred to as a first head end, and second video head end equipment 402-2, also referred to as a second head end. The first and second head ends 402-1 and 402-2 are coupled to the transport network 102T via respective Ethernet switches 404-1 and 404-2. It is assumed for this embodiment that the first and second head ends 402-1 and 402-2 are operated by the same television service provider, although in other embodiments the different head ends may be associated with different service providers.

In the system 400, home location 104H and remote location 104R access transport network 102T via DSLAMs 410-1 and 410-2 of access networks 102A-1 and 102A-2, respectively. The access networks 102A-1 and 102A-2 are coupled to the transport network 102T via respective Ethernet switches 406-1 and 406-2, which are coupled to respective BRAS elements 408-1 and 408-2.

Like FIGS. 3A and 3B, FIG. 4 shows the roaming of first subscriber Mark to remote location 104R corresponding to the home location of second subscriber Steve, with Mark being provided with access to the NFL® channel at the remote location. As in the FIG. 3B scenario, the BRAS element 408-2 does not store subscriber information for Mark, and thus requests the subscriber information from BRAS elements 408-1, as indicated generally at 420, possibly using a control network such as that previously described.

The system 400 is also configured to provide the first subscriber Mark with access to a number of additional media streams, corresponding to subscription television services which would otherwise be accessible only from his home location 104H, at the remote location 104R. In this example, these streams include, in addition to the stream corresponding to the NFL® channel as previously described, a stream associated with a 6 PM evening news program local to the home location 104H, and a stream associated with network video recording (NVR) material recorded by Mark using network equipment. Both of these additional streams are delivered as unicast streams from the first head end 402-1, via Ethernet switches 404-1, 404-2 and 406-2 and DSLAM 410-2, to the remote location 104R. Such an arrangement recognizes that the home and remote locations may be in different geographic regions having different local broadcast channels, and the roaming subscriber may prefer access to his or her own local broadcast channels or personal NVR content.

Any programming content that is accessible to first subscriber Mark at his home location 104H via the first head end 402-1 but is not available from the second head end 402-2 may be transported to remote location 104R as one or more unicast streams. Other streaming arrangements are also possible. For example, one or more streams could be multicast rather than unicast if there are several roaming subscribers wishing to watch a particular subscription television channel.

An electronic programming guide from the home location may also be made available to the roaming subscriber at the remote location. Such a programming guide will preferably have the same “look and feel” as the programming guide at the home location, for example, the same layout, color scheme, displayed information, etc. Generally, the illustrative embodiments attempt to replicate the home location subscriber experience at the remote location, but without requiring the subscriber to carry any particular equipment or other devices from the home location to the remote location. Access to subscription services at remote locations is therefore provided in a manner which is substantially independent of any particular subscriber device utilized at the home location.

Those channels delivered to the roaming subscriber that are available from the head end 402-2 serving the remote location 104R may continue to be sourced from that head end, while only those channels not available from head end 402-2 are transported to DSLAM 410-2 from the head end 402-1 serving the home location 104H. Thus, in the regional roaming scenario of FIG. 4, the roaming subscriber may receive subscriber television channels from different head ends. The particular head ends used to source various channels may be varied dynamically to achieve load balancing or other system objectives.

FIG. 5 illustrates a potentially global roaming scenario in which the remote location is served by different DSLAM and BRAS elements, different video head end equipment, and a different transport network than the home location. Signal distribution system 500 comprises first video head end equipment 502-1, also referred to as a first head end, and second video head end equipment 502-2, also referred to as a second head end. The first and second head ends 502-1 and 502-2 are coupled to respective transport networks 102T-1 and 102T-2 via respective Ethernet switches 504-1 and 504-2. It is assumed for this embodiment that the first and second head ends 502-1 and 502-2 are operated by different television service providers, denoted in the figure as service provider 1 and service provider 2, potentially separated by large geographic distances.

In the system 500, home location 104H and remote location 104R access transport networks 102T-1 and 102T-2 via DSLAMs 510-1 and 510-2 of access networks 102A-1 and 102A-2, respectively. The access networks 102A-1 and 102A-2 are coupled to the respective transport networks 102T-1 and 102T-2 via respective Ethernet switches 506-1 and 506-2, which are coupled to respective BRAS elements 508-1 and 508-2.

Like FIGS. 3A, 3B and 4, FIG. 5 shows the roaming of first subscriber Mark to remote location 104R corresponding to the home location of second subscriber Steve, with Mark being provided with access to the NFL® channel at the remote location. As in the scenarios of FIGS. 3B and 4, the BRAS element 508-2 does not store subscriber information for Mark, and thus requests the subscriber information from video head end equipment 502-1, as indicated generally at 520.

The system 500 is also configured to provide the first subscriber Mark with access to a number of additional media streams, corresponding to subscription television services which would otherwise be accessible only from his home location 104H, at the remote location 104R. In this example, these streams include, in addition to the stream corresponding to the NFL® channel as previously described, a stream associated with a 6 PM evening news program local to the home location 104H, and a stream associated with NVR material recorded by Mark using network equipment. Both of these additional streams are delivered as unicast streams from the first head end 502-1, via Ethernet switches 504-1, 504-2 and 506-2 and DSLAM 510-2, to the remote location 104R.

It will generally be desirable in the roaming arrangement of FIG. 5 for the two service providers to have an agreement in place for communication of subscriber information between the two entities.

The above-described embodiments of the invention are intended to be illustrative only. For example, although described in the context of particular signal distribution systems, the invention is not restricted to use in such systems. The described roaming television services techniques can be adapted in a straightforward manner to a wide variety of alternative systems, using different arrangements of system elements. As indicated above, the techniques can be applied to a wide variety of subscription media services, including subscription audio services delivered via digital satellite radio, and to other arrangements for delivering signals associated with subscription media services.

Also, the particular manner in which a subscriber provides authentication information to a service provider and receives media streams therefrom at a remote location may be varied in alternative embodiments to accommodate the needs of a given application. The authentication information may include, again by way of example, a user account and password, or any other information suitable for identifying a subscriber to the satisfaction of a particular service provider.

Further, the media streams that are delivered to a remote location on behalf of a given subscriber may include any type of data, including, for example, digital audio, video, speech or other information signals, in any combination.

These and numerous other alternative embodiments within the scope of the following claims will be readily apparent to those skilled in the art.

We claim:

1. A method of providing access to one or more of a plurality of subscription services of a signal distribution system to a system user at a location remote from a home location of the user, the method comprising the steps of:
receiving from the remote location authentication information relating to the user; and
determining one or more of the plurality of subscription services that are accessible to the user at the home location;
wherein one or more media streams are delivered to the remote location based on the determination as to which of the plurality of subscription services are accessible to the user at the home location.

2. The method of claim 1 wherein the plurality of subscription services comprises a plurality of subscription television services.

3. The method of claim 1 wherein the user has accessibility to the one or more of the plurality of subscription services at the home location via a first interface device of the system and provides the authentication information at the remote location via a second interface device of the system.

4. The method of claim 2 wherein the signal distribution system comprises a cable television system.

5. The method of claim 2 wherein the signal distribution system comprises a satellite television system.

6. The method of claim 2 wherein the signal distribution system comprises a system providing Internet protocol television over at least one of digital subscriber line and fiber.

7. The method of claim 2 wherein the plurality of subscription television services comprise a plurality of broadcast channels and a plurality of premium programming channels.

8. The method of claim 7 wherein the broadcast channels and at least a given one of the premium programming channels are accessible to the user at the home location, and only the broadcast channels would otherwise be accessible at the remote location, the delivering step further comprising delivering to the remote location one or more media streams corresponding to the given premium programming channel.

9. The method of claim 2 wherein the home location and the remote location are served by a common subscription television service provider.

10. The method of claim 2 wherein the home location and the remote location are served by respective first and second subscription television service providers that are different from one another.

11. The method of claim 1 wherein the one or more streams comprise at least a first media stream delivered to the remote location from first head end equipment associated with the home location and a second media stream delivered to the remote location from second head end equipment associated with the remote location.

12. The method of claim 1 further including the step of generating a billing record including charges for delivery of the one or more media streams to the remote location.

13. The method of claim 12 wherein the charges of the billing record are combined with charges associated with providing access to the one or more subscription services to the user at the home location.

14. An apparatus for providing access to one or more of a plurality of subscription services of a signal distribution system to a system user at a location remote from a home location of the user, the apparatus comprising:
an interface device comprising a processor and a memory coupled to the processor;
wherein the processor is operative to control the transmission from the remote location of authentication information relating to the user, the authentication information being utilizable in determining of one or more of the plurality of subscription services that are accessible to the user at the home location; and
wherein one or more media streams are delivered to the remote location based on the determination as to which of the plurality of subscription services are accessible to the user at the home location.

15. The apparatus of claim 14 wherein the interface device is configured to include a capability for presenting the one or more media streams.

16. The apparatus of claim 14 wherein the interface device is coupled to a media presentation device which is configured to present the one or more media streams.

17. A signal distribution system for providing access to one or more of a plurality of subscription services to a system user at a location remote from a home location of the user, the system comprising:
a plurality of interface devices, at least one of which is at the remote location;
head end equipment operative to receive from the interface device at the remote location authentication information relating to the user, and to determine one or more of the plurality of subscription services that are accessible to the user at the home location;
wherein one or more media streams are delivered from the head end equipment to the interface device at the remote location based on the determination as to which of the plurality of subscription services are accessible to the user at the home location.

18. The system of claim 17 wherein the interface device at the remote location comprises at least one of a set-top box and a receiver.

19. The system of claim 17 wherein the head end equipment comprises at least one of a broadband remote access server, a server associated with a local head end, and an Internet protocol video server.

20. An article of manufacture comprising a machine-readable medium storing one or more programs for use in providing access to one or more of a plurality of subscription services of a signal distribution system to a system user at a location remote from a home location of the user, the one or more programs when executed in a processor performing the steps of:
receiving from the remote location authentication information relating to the user; and
determining one or more of the plurality of subscription services that are accessible to the user at the home location;
wherein one or more media streams are delivered to the remote location based on the determination as to which of the plurality of subscription services are accessible to the user at the home location.

21. An apparatus for providing access to one or more of a plurality of subscription services of a signal distribution system to a system user at a location remote from a home location of the user, the apparatus comprising:
head end equipment operative to receive from the remote location authentication information relating to the user, and to determine one or more of the plurality of subscription services that are accessible to the user at the home location;
wherein one or more media streams are delivered to the remote location based on the determination as to which of the plurality of subscription services are accessible to the user at the home location.

22. The apparatus of claim 21 wherein the head end equipment comprises at least one of a broadband remote access server, a server associated with a local head end, and an Internet protocol video server.

23. The apparatus of claim 21 wherein the home location and the remote location are coupled to respective first and second head ends of the system via respective first and second networks.
